(19) United States
(12) Patent Application Publication
(10) Pub. No.: US 2004/0080473 A1
(43) Pub. Date: Apr. 29, 2004

(54) Display panel drive system

(75) Inventors: Takeshi Higuma, Kawagoe-shi (JP); Masaru Sasaki, Kawagoe-shi (JP); Hiroyuki Kazama, Kawagoe-shi (JP); Junichi Miyakawa, Kawagoe-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/688,981

(22) Filed: Oct. 21, 2003

(30) Foreign Application Priority Data
Oct. 21, 2002 (JP) 2002-305948

(51) Int. Cl. G09G 3/30

(52) U.S. Cl. 345/76

(57) ABSTRACT

The present invention provides a display panel drive system that can reduce the driver circuit power consumption and heat generation. The lighting rate of the light emitting elements in the display panel is calculated. The higher the lighting rate is, the higher the value of the voltage supplied to the driver circuit for driving the light emitting elements is set. The calculation of the lighting rate may be performed for each frame or each line of the display screen.

### BACKGROUND OF THE INVENTION

1. Field of the Invention

The present invention relates to a drive system for a display panel that has, for example, organic electroluminescent (referred to simply as “organic EL” hereinafter) elements.

2. Description of the Related Art

Conventionally, organic EL display panels have organic EL elements arranged in the form of a matrix on a panel. The display panel is driven by an anode driver circuit and a cathode driver circuit. These driver circuits are often constituted by single-chip ICs (integrated circuits) in order to miniaturize the organic EL display system.

Generally, a drive current for the organic EL elements on the panel is supplied from the anode driver IC to the organic EL elements and then flows to the cathode driver IC. The anode driver IC contains a plurality of constant current circuits such that one constant current circuit is associated with each column of the organic EL elements on the panel. These constant current circuits use a voltage Va, which is supplied by the supply circuit for an anode driver IC, to generate a constant drive current “Idrv” for lighting an organic EL element.

Therefore, the output-stage transistors of the constant current circuits in the anode driver IC drive the organic EL elements at the constant current, i.e., the drive current Idrv. The organic EL elements are the load of the constant current circuits in the anode driver IC. Consequently, the drain-source voltage Vds of the output-stage transistor must have an adequate margin to the drain-source saturation voltage so that the transistor operates reliably in the saturation condition even when all the organic EL elements are lit.

Because an aluminum alloy is generally used for the wiring connecting the organic EL elements with the cathode driver IC, the influence of the wiring impedance is not negligible. As the distance between the organic EL elements and the cathode driver IC increases, the potential on the cathode side of the organic EL elements rises due to the voltage drop caused by the cathode wiring impedance. That is, the further the positions of the organic EL elements on the panel from the cathode driver IC, the higher the potential on the anode side which is required for light emission. If all the organic EL elements on the panel are lit, an anode voltage Van, which is generated at the anodes of organic EL elements located in the column furthest from the cathode driver IC, is highest. Consequently, the voltage Va supplied to the anode driver IC must be determined with this point in mind.

The voltage Va supplied to the anode driver IC should satisfy the following relationship:

Va≧Vds+Van (1)

That is, the supply voltage Va must be set to an adequately high voltage in order to have the drain-source voltage Vds which allows the output-stage transistor of the constant current circuit to operate in the saturation region even when all the organic EL elements on the panel are lit and the anode potential of the organic EL elements is at a maximum.

In general, it is extremely rare that the lighting rate that indicates the percentage (proportion) of lit elements among the organic EL elements on the panel is 100%. The lighting rate is often some 50% on average.

The power consumption of the anode driver IC is represented by “P.” Because the electric power is mainly consumed at the output stage of the anode driver IC, the power consumption P is defined as follows:

P=Vds×Idrv×(the number of output-stage transistors which are ON) (2)

As is clear from the above equation (1), when the lighting rate falls and the anode potential of the organic EL elements drops, the drain-source voltage Vds increases because the supply voltage Va is constant. As a result, the power consumption P of the anode driver IC increases and there is a risk of a sudden increase in the heat generated by the anode driver IC.

Generally, organic EL elements are susceptible to the effects of heat. When the ambient temperature of the organic EL element increases, the luminance lifetime of the organic EL element tends to fall rapidly. Thus, if the heat generated by the anode driver IC increases, and the temperature of the organic EL elements near the anode driver IC also rises, then there is the risk of shortening the luminance lifetime of the organic EL elements. In addition, nowadays, due to the demand to miniaturize and reduce the product costs of organic EL display panels, the COG (Chip On Glass) method which directly crimps the bare chip of the anode driver IC onto the glass of the display panel is coming into widespread use. In this method, the distance between the anode driver IC and the organic EL elements continues to decrease. Hence, a reduction in the amount of heat generated by the anode driver IC is critical.

Japanese Patent Kokai (Laid Open Publication) No. 2002-175046 discloses a technique for preventing a drop in the quality of the display image caused by the heat generation of organic EL elements in a display panel.

### SUMMARY OF THE INVENTION

According to one aspect of the present invention, there is provided a drive system for a display panel including a plurality of light emitting display elements. The drive system includes a driver circuit for driving the display panel. The drive system also includes a power supply circuit for supplying a supply voltage to the driver circuit. The value of the supply voltage is regulated in accordance with a voltage control signal. Pixel data which is displayed on the display panel is stored in a storage circuit. The drive system further includes a control circuit for generating lighting instructions for the display panel on the basis of pixel data extracted from the pixel data storage circuit at a predetermined timing and then supplying the lighting instructions to the driver circuit. The control circuit generates the voltage control signal to increase the supply voltage when a lighting rate determined by the lighting instructions is high and generates the voltage control signal to reduce the supply voltage when the lighting rate is low.

### BRIEF DESCRIPTION OF THE DRAWINGS

FIG. 1 illustrates a block diagram of a drive system for an organic EL display panel according to one embodiment of the present invention, together with the organic EL display panel;

FIG. 2 illustrates a detail of driver ICs used in the drive system in FIG. 1, together with the organic EL display panel; and

FIGS. 3A to 3D are a set of time charts for voltage control operations of the organic EL display panel drive system shown in FIG. 1.

### DETAILED DESCRIPTION OF THE INVENTION

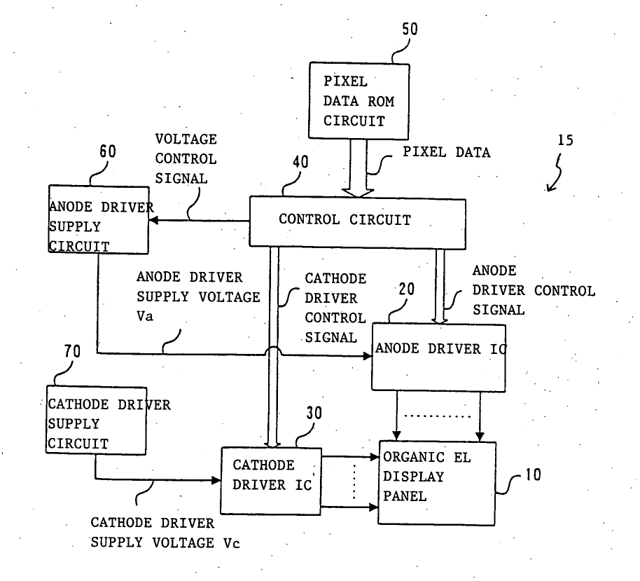

One embodiment of a display panel drive system to which the present invention is applied will be described with reference to FIG. 1. Specifically, a drive system for a display panel having organic EL elements as light emitting elements will be described.

First, the structure of the organic EL display panel drive system 15 and the display panel 10 will be described.

In FIG. 1, the organic EL display panel 10 has a number of organic EL elements arranged in a matrix. The organic EL elements on the display panel are driven by an anode driver IC 20 and a cathode driver IC 30 so that the organic EL elements light up. The driver ICs 20 and 30 are controlled by control signals from a control circuit 40.

The control circuit 40 is principally constituted by a microcomputer, a memory circuit and peripheral circuits therefore (not shown). The memory circuit includes memory elements such as a RAM and a ROM. Programs for controlling the various operations of the display panel drive system 15 are stored in the memory circuit of the control circuit 40, and the microcomputer of the control circuit 40 executes these programs at a predetermined timing. If there is a large number of organic EL elements provided on the panel, the control circuit 40 may further contain a dedicated display processing controller for performing display processing exclusively in order to decrease the processing by the microcomputer. Alternatively, a separate display processing controller IC may be provided in addition to the microcomputer.

The pixel data ROM circuit 50 is a storage circuit for storing pixel data which is displayed on the organic EL display panel 10. The control circuit 40 reads pixel data from the pixel data storage circuit 50 at a predetermined timing, and the pixel data are used for the display data displayed on the organic EL display panel 10.

An anode driver supply circuit 60 and a cathode driver supply circuit 70 are supply circuits (power source circuits) for supplying voltages to the driver ICs 20 and 30 so as to drive the organic EL elements. The anode driver voltage Va is supplied to the anode driver IC 20 by the anode driver supply circuit 60, while a cathode driver voltage Vc is supplied to the cathode driver IC 30 by the cathode driver supply circuit 70. The value of the supply voltage Va is regulated by a voltage control signal from the control circuit 40.

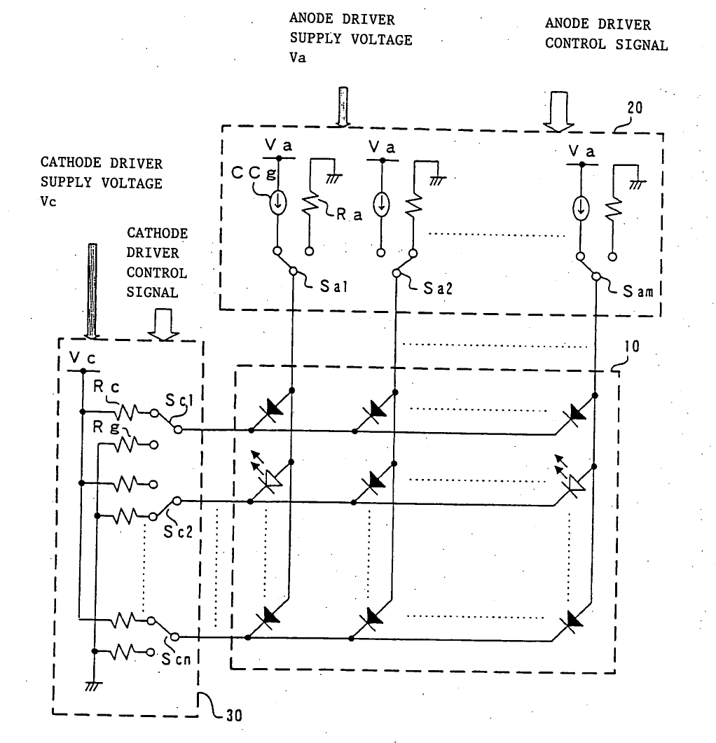

Next, the constitution of the organic EL display panel 10, the anode driver IC 20, and the cathode driver IC 30 will be described along with the operation thereof, with reference to the block diagram shown in FIG. 2.

The organic EL display panel 10 shown in FIG. 2 has a so-called simple matrix constitution, i.e., the organic EL elements are arranged in a matrix shape on the panel to form the “n row×m column” matrix. A simple matrix configuration is generally adopted for a part color organic EL display panel so as to reduce product costs. Each organic EL element has an organic EL light emission layer sandwiched between an anode electrode and a cathode electrode, and possesses a current rectification characteristic like that of an ordinary diode. In FIG. 2, the anodes of the organic EL elements are line-concentrated for each of the columns and connected to the anode driver IC 20, and the cathodes of the organic EL elements are line-concentrated for each of the rows and connected to the cathode driver IC 30.

The anode driver IC 20 includes switch elements Sa1 to Sam, constant current circuits CCg and pull-down resistors Ra. One switch element is associated with one constant current circuit CCg and one pull-down resistor Ra. The switching operations of the switch elements Sa1 to Sam are controlled by anode driver control signals supplied from the control circuit 40. The output-stage transistor of the constant current circuit CCg is, for example, a PMOS-FET. The constant current circuit CCg generates an organic EL element drive current Idrv on the basis of the voltage Va supplied by the anode driver supply circuit 60.

The cathode driver IC 30 includes switch elements Sc1 to Scn, pull-up resistors Rc and pull-down resistors Rg. One switch element is associated with one pull-up resistor Rc and one pull-down resistor Rg. The switching operations of the switch elements Sc1 to Scn are controlled by cathode driver control signals supplied from the control circuit 40.

The operations of the circuits shown in FIG. 2 will now be described.

First, the control circuit 40 (FIG. 1) supplies the cathode driver control signal, which selects a desired scan line (horizontal display line) from 1 to n rows, to the cathode driver IC 30. The cathode driver IC 30 switches the switch element, which corresponds to the line (row) designated by the control signal, from the pull-up resistor Rc side to the pull-down resistor Rg side. In FIG. 2, the second row is selected as the scan line. As a result, only the switch element Sc2 is switched over to the pull-down resistor Rg side, and other switch elements are all set to the pull-up resistor Rc side.

The control circuit 40 reads the pixel data required for the selected scan line(s) from the pixel data ROM circuit 50 and edits (prepares) display data. The control circuit 40 then supplies the display data to the anode driver IC 20 as the anode driver control signal. The anode driver IC 20 switches the switch elements of the columns on the panel which are to be lit from the pull-down resistor Rg side to the constant current circuit CCg side on the basis of the control signal. In FIG. 2, the control signal instructs lighting of the first column and the mth column. Thus, the switch elements Sa1 and Sam are switched over from the pull-down resistor Ra side to the constant current circuit CCg side, while other switch elements are all set to the pull-down resistor Ra side.

As a result of performing the above operation, the drive current Idrv flows to the organic EL elements of the first column and the mth column in the second row on the panel, so that these organic EL elements emit light. The anodes of the other organic EL elements are grounded via the pull-down resistors Ra in the anode driver IC 20 while the cathodes of these EL elements are pulled up to the supply voltage Vc via the pull-up resistors Rc in the cathode driver IC 30, and therefore these organic EL elements do not light up.

By control signals from the control circuit 40, the cathode driver IC 30 sequentially scans at a predetermined scanning timing and the anode driver IC 20 receives the display data for the respective scan lines in sync with the scanning timing, thereby displaying a desired image on the organic EL display panel 10.

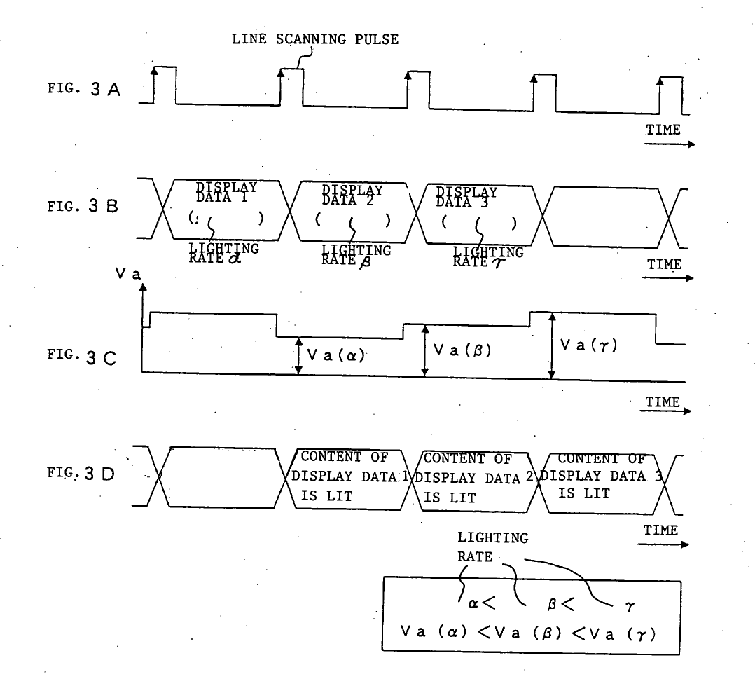

Next, the voltage control operation will be described with reference to the operation time charts shown in FIGS. 3A to 3D.

FIGS. 3A to 3D is a set of time charts that show the display data (which designates EL elements to be lit) for the scan lines of the organic EL display panel 10, and the change in the voltage Va supplied to the anode driver IC 20. Specifically, FIG. 3A shows a line scanning pulse for scanning lines of 1 to n rows of the organic EL display panel 10. FIG. 3B shows display data which is set in the buffer memory of the control circuit 40. FIG. 3C shows the change in the voltage Va supplied from the anode driver supply circuit 60 to the anode driver IC 20. FIG. 3D shows display data which is set in the register in the anode driver IC 20. FIG. 3D shows the actual lit states of the organic EL elements on the display lines.

The line scanning pulse shown in FIG. 3A is supplied each time one line of the organic EL display panel 10 is scanned on the basis of instructions from the control circuit 40. That is, the line scanning of the cathode driver IC 30 is performed in the pulse cycles shown in FIG. 3A.

The control circuit 40 reads pixel data from the pixel data ROM circuit by accessing the pixel data ROM circuit at an arbitrary timing (e.g., at the rising edge of the line scanning pulse in FIG. 3A). The control circuit 40 then generates display data to be displayed in the next scan line, stores this display data in the buffer memory provided in the control circuit 40, and transfers the display data to the anode driver IC 20 (FIG. 3B).

The control circuit 40 calculates the lighting rate of the display data at the same time the display data is generated. In this embodiment, the lighting rate indicates the proportion of the quantity of the organic EL elements which are lit by the display data on one display line of the organic EL display panel. For example, if 100 organic EL elements are provided on one display line and 20 organic EL elements are lit by the display data, then the lighting rate is 0.2 (=20/100).

The control circuit 40 generates a voltage control signal which is supplied to the anode driver supply circuit 60 on the basis of the lighting rate thus calculated.

When the next line scanning pulse rises, the anode driver supply circuit 60 gets the voltage control signal from the control circuit 40 and determines the value of the supply voltage that is supplied to the anode driver IC 20.

For example, supposing that the maximum value of the voltage supplied to the anode driver IC 20 is Va and the lighting rate is α(0≦α≦1), then the supply voltage Va(α) may simply be set as Va(α)=Va×α. Alternatively, another equation or function for deriving the supply voltage Va(α) from the lighting rate a may be established beforehand, and the supply voltage Va(α) may be calculated from this equation. Alternatively, a conversion table which indicates (pre-fixes) the relationship between the lighting rate a and the supply voltage Va(α) may be prepared, and the supply voltage Va(α) may be determined by using this table.

The anode driver IC 20 also receives the display data from the buffer memory of the control circuit 40 when the next line scanning pulse rises (FIG. 3B), and latches the display data into the register of the anode driver IC 20 (FIG. 3D).

Therefore, when the contents of the display data 1 (with the lighting rate α) are lit on the scan line concerned, i.e., when the display data 1 is latched by the register in the anode driver IC 20, the voltage supplied to the anode driver IC 20 is then Va(α). Likewise, when display data 2 (with the lighting rate β) is latched by the anode driver IC 20, the voltage supplied to the anode driver IC 20 is Va(β), and when display data 3 (with the lighting rate γ) is latched by the anode driver IC 20, the voltage supplied to the anode driver IC 20 is Va(γ).

If the display data lighting rates α, β and γ have the relationship of α<β<γ, then the relationship of Va(α)<Va(β)<Va(γ) is usually established for the voltages supplied to the anode driver IC 20.

As described above, in this embodiment, the voltage supplied to the anode driver IC 20 is regulated by the lighting rate of the display data such that the higher the lighting rate, the higher the supply voltage is set. Consequently, the drain-source voltage Vds of the output-stage transistor of the constant current circuit of the anode driver IC 20 can always be kept at the appropriate value and hence wasteful power consumption by this transistor can be suppressed. At the same time, the heat generation of the anode driver IC 20 is suppressed, or unnecessary heat generation occurs.

In the embodiment described above, the supply voltage supplied to the anode driver IC 20 is controlled each time a single line of the display screen is scanned, but the present invention is not limited to or by this example.

For instance, a buffer memory that is capable of storing display data for a plurality of rows (i.e., a plurality of display lines) may be provided in the control circuit 40. The display data may be first stored in this buffer memory, the lighting rate for the whole of this stored data may be calculated, and control of the supply voltage Va for these lines may be performed on the basis of the lighting rate.

Alternatively, the capacity of the buffer memory may be increased, the display data of a whole frame may be stored in the buffer memory, the lighting rate for the display data of a whole frame may be calculated, and control of the supply voltage Va may be carried out for each frame.

Alternatively, a large-capacity buffer memory may be provided, the display data of plurality of frames may be stored in this buffer memory, the lighting rate for the display data of the frames may be calculated, and control of the supply voltage Va may be performed for the frames.

If the lighting rate is calculated for each line or frame, a fluctuation range of the lighting rates for several lines or frames may be detected, and control of the supply voltage Va may be carried out only when this fluctuation range exceeds a predetermined threshold value.

The supply voltage control for the line may be combined with the supply voltage control for the frame in accordance with the lighting rate fluctuation range.

Although the organic EL elements are used as light emitting elements in the above embodiment, the present invention is not limited to or by this example.

This application is based on a Japanese Patent Application No. 2002-305948, and the entire disclosure thereof is incorporated herein by reference.

What is claimed is:

1. A drive system for a display panel having a plurality of light emitting elements, the drive system comprising:
a driver circuit for driving the display panel;
a power supply circuit for supplying a supply voltage to the driver circuit, a value of the supply voltage being regulated in accordance with a voltage control signal;
a pixel data storage circuit for storing pixel data displayed on the display panel; and
a control circuit for generating lighting instructions for the display panel based on pixel data extracted from the pixel data storage circuit at a predetermined timing and supplying the lighting instructions to the driver circuit, the control circuit also generating the voltage control signal for changing the value of the supply voltage in accordance with a lighting rate.

2. The drive system according to claim 1, wherein the control circuit calculates the lighting rate at least for each single frame of image data displayed on the display panel.

3. The drive system according to claim 1, wherein the control circuit calculates the lighting rate at least for each single line of image data displayed on the display panel.

4. The drive system according to claim 1, wherein the light emitting elements are organic EL light emitting elements.

5. The drive system according to claim 1, wherein the lighting rate is a percentage of the light emitting elements to be lit in accordance with the lighting instructions.

6. The drive system according to claim 4, wherein the organic EL elements are arranged in a matrix having a plurality of rows and a plurality of columns, the drive circuit includes an anode driver IC for a plurality of columns of organic EL elements and a cathode driver IC for a plurality of rows of organic EL elements, and the regulated supply voltage is supplied to the anode driver IC.

7. The drive system according to claim 1, wherein the control circuit generates the voltage control signal for increasing the value of the supply voltage when the lighting rate increases, and for decreasing the value of the supply voltage when the lighting rate decreases.

8. The drive system according to claim 1, wherein the control circuit generates the voltage control signal for regulating the value of the supply voltage when the lighting rate exceeds a predetermined value.

9. An apparatus for driving a display panel having a plurality of light emitting elements, the apparatus comprising:
drive means for driving the display panel;
means for supplying a supply voltage to the drive means, a value of the supply voltage being regulated in accordance with a voltage control signal;
storage means for storing pixel data displayed on the display panel; and
control means for generating lighting instructions for the display panel based on pixel data extracted from the storage means at a predetermined timing and supplying the lighting instructions to the drive means, the control means also generating the voltage control signal for regulating the value of the supply voltage in accordance with a lighting rate.

10. The apparatus according to claim 9, wherein the control means calculates the lighting rate at least for each single frame of image data displayed on the display panel.

11. The apparatus according to claim 9, wherein the control means calculates the lighting rate at least for each single line of image data displayed on the display panel.

12. The apparatus according to claim 9, wherein the light emitting elements are organic EL light emitting elements.

13. The apparatus according to claim 9, wherein the lighting rate is a percentage of the light emitting elements to be lit in accordance with the lighting instructions.

14. The apparatus according to claim 12, wherein the organic EL elements are arranged in a matrix having a plurality of rows and a plurality of columns, the drive means includes an anode driver means for a plurality of columns of organic EL elements and a cathode driver means for a plurality of rows of organic EL elements, and the regulated supply voltage is supplied to the anode driver means.

15. The apparatus according to claim 9, wherein the control means generates the voltage control signal for increasing the value of the supply voltage when the lighting rate increases, and for decreasing the value of the supply voltage when the lighting rate decreases.

16. The apparatus according to claim 9, wherein the control means generates the voltage control signal for regulating the value of the supply voltage when the lighting rate exceeds a predetermined value.

17. A method of driving a display panel having a plurality of light emitting elements based on a supply voltage supplied from a supply circuit, the method comprising:
calculating a lighting rate of a predetermined group of light emitting elements when lighting instructions are given to the predetermined group of light emitting elements; and
determining a value of the supply voltage based on the lighting rate.

18. The method according to claim 17, wherein the predetermined group of light emitting elements corresponds to one frame of image data displayed on the display panel.

19. The method according to claim 17, wherein the predetermined group of light emitting elements corresponds to one horizontal line of image data displayed on the display panel.

20. The method according to claim 17, wherein the light emitting elements are organic EL light emitting elements.

21. The method according to claim 17, wherein the value of the supply voltage is increased when the lighting rate increases, and is decreased when the lighting rate decreases.
